(19) United States
(12) Patent Application Publication
(10) Pub. No.: US 2024/0308600 A1
(43) Pub. Date: Sep. 19, 2024

(54) AERODYNAMIC DEVICE COMBINATIONS FOR INTERMODAL CHASSIS

(71) Applicant: Trevor Pan, Tempe, AZ (US)

(72) Inventor: Trevor Pan, Tempe, AZ (US)

(21) Appl. No.: 18/402,292

(22) Filed: Jan. 2, 2024

Related U.S. Application Data
(60) Provisional application No. 63/436,682, filed on Jan. 2, 2023.

(51) Int. Cl. B62D 35/00

(52) U.S. Cl. CPC B62D 35/001; B62D 35/008

(57) ABSTRACT

A combination of tilt fairings, pliable membranes, pliable membrane applicators and roll-up skirts mounted to an intermodal chassis provides reduction in aerodynamic drag of a series 1 freight container while in transit. A further embodiment utilizes collapsible skirts mounted to the intermodal chassis.

### CROSS-REFERENCE TO RELATED APPLICATIONS

Provisional application of Serial No. U.S. 63/436,682, filed Jan. 2, 2023.

### STATEMENT REGARDING FEDERALLY SPONSORED RESEARCH OR DEVELOPMENT

None.

### BACKGROUND

### Field of the Invention

The present invention is directed to a combination of aerodynamic fairings, skirts, and skins sized and adapted to greatly improve fuel efficiencies when towing a series 1 freight container on an intermodal chassis.

### Description of the Related Art

Previously, the need to remove containers from the chassis, and stack chassis at yards provided a lot of obstacles to creating fairings that improve full efficiency. This is unlike a semi-truck and dry van, which are not removed and replaced on a daily basis.

Because semi-trucks with dry vans are essentially stationary fairings, skirts and the like are easy to add to a dry van (trailer).

Connecting to the underside of the dry van is simple and once connected will have little interference as goods are moved in and out of the rear doors.

### BRIEF SUMMARY

In one embodiment of the present invention a motorized tilt fairing is bolted to an existing intermodal chassis and is powered by the semi-truck 12v battery. The structure for the fairing enables the fairing to tilt away from an end of a series 1 freight container so that a spreader may lift or lower a container on the chassis. After a container has been removed the tilt fairing may be motored over the top of the chassis such that the fairing may gain a low profile when the chassis is empty, and the truck needs to transit to pick up another container.

In another embodiment the tilt fairings may collapse, and or fold to gain an even lower profile to the chassis.

In another embodiment the tilt fairings may pivot with hinges at the sides of the chassis outwards and enable the truck to back up to a dock for unloading. This is a separate use case where a container is not removed from the chassis.

In another embodiment the tilt fairings may provide space for a roll applicator and skin to be used for skinning a container with motorized means. Another name for this is the pliable membrane applicator.

In another embodiment the tilt fairings may provide space for a roll applicator and skin to be used for skinning a container with hand drawn means, such that a trucker may pull the skin along the side of the container.

In another embodiment side skirts are permanently affixed to an intermodal chassis. This enables container shipments to enjoy better fuel consumption, but also not interfere with the lowering of the container on the intermodal chassis.

In another embodiment the side skirts are collapsible and enable the intermodal chassis to be stacked without damage from wheels of other intermodal chassis. Further, these skirts may have hinges to tuck completely in the web of the wide flange beams that make up a typical chassis. Or, they may stow way between that chassis beams. It depends on the intermodal chassis make and model.

In another embodiment the side skirts roll up over a rack and pinion skin applicator device. This allows a skirt to be used in conjunction with a pliable membrane applicator.

### BRIEF DESCRIPTION OF THE DRA WINGS

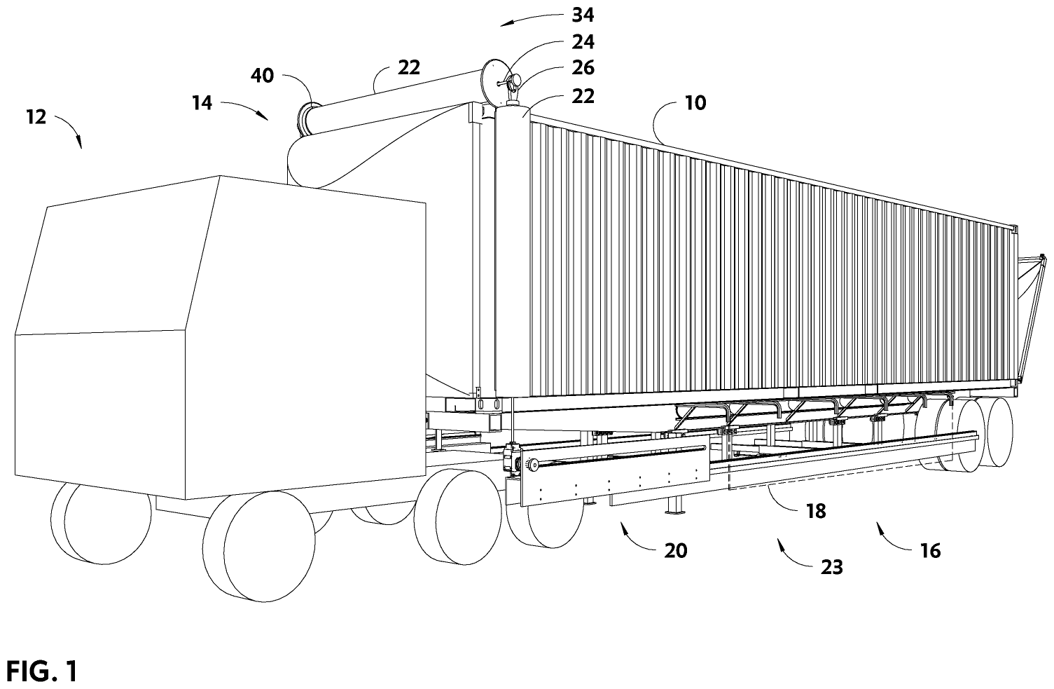

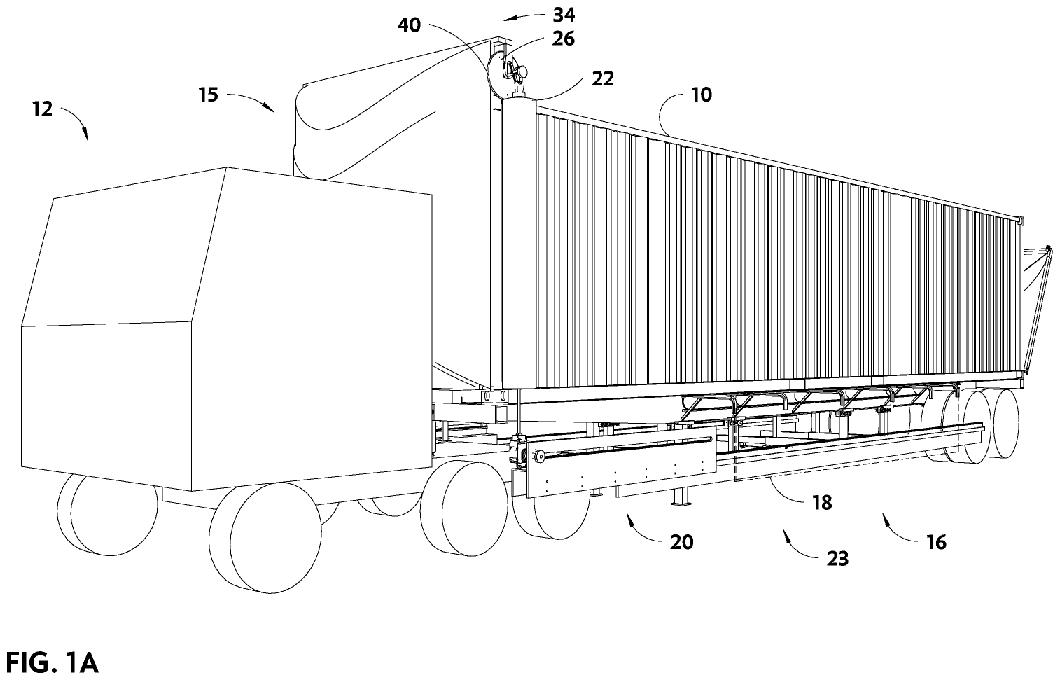

FIG. 1A side front perspective view of a prior art semi-truck, and intermodal chassis with a series 1 freight container. Tilt fairings, roll-down skirts and a skin applicator are also depicted.

FIG. 1A A view that largely follows FIG. 1 further including an extended tilt fairing with a means for storing a top skin, and spindle.

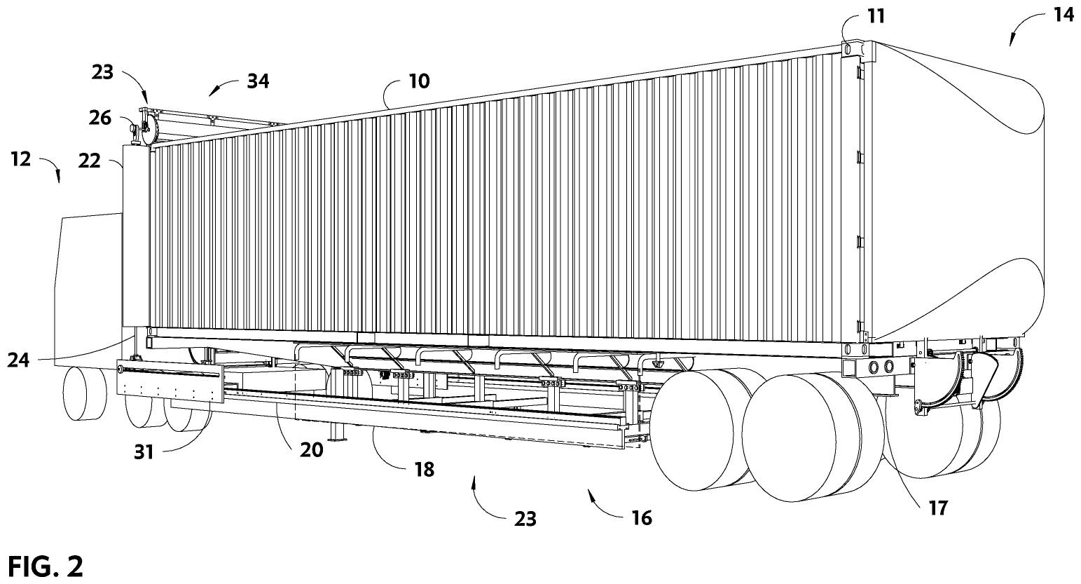

FIG. 2A side rear perspective view of a prior art semi-truck and intermodal chassis with a series 1 freight container. Tilt fairings, roll-down skirts and a skin applicator are also depicted.

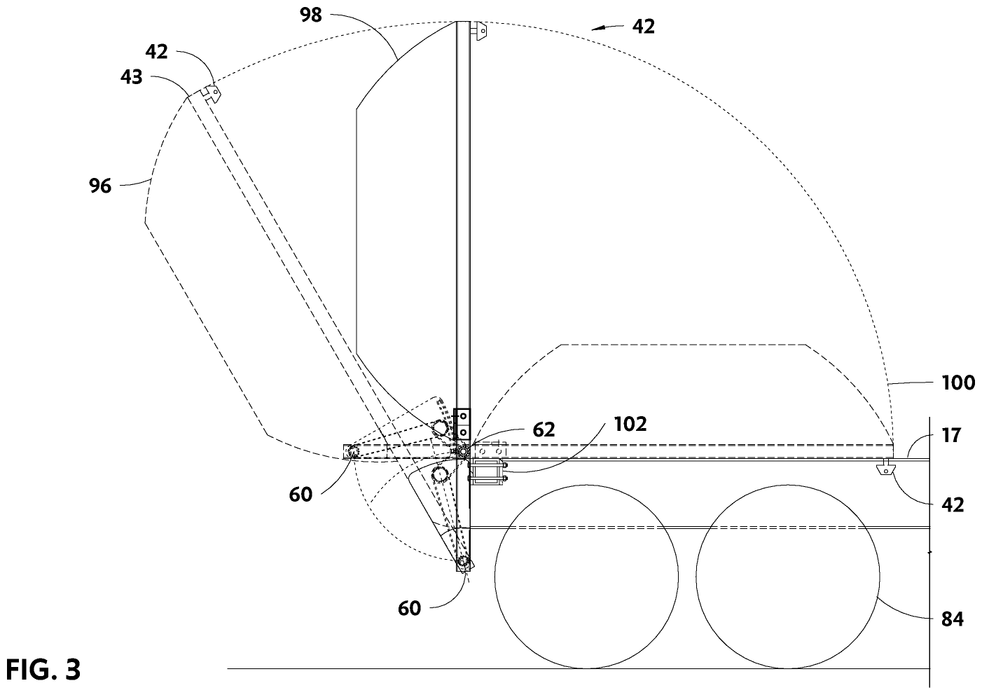

FIG. 3A section view of a tilt fairing at the rear of an intermodal chassis. Also shown are the various positions the tilt fairing may be employed; open position, upright position and prone position.

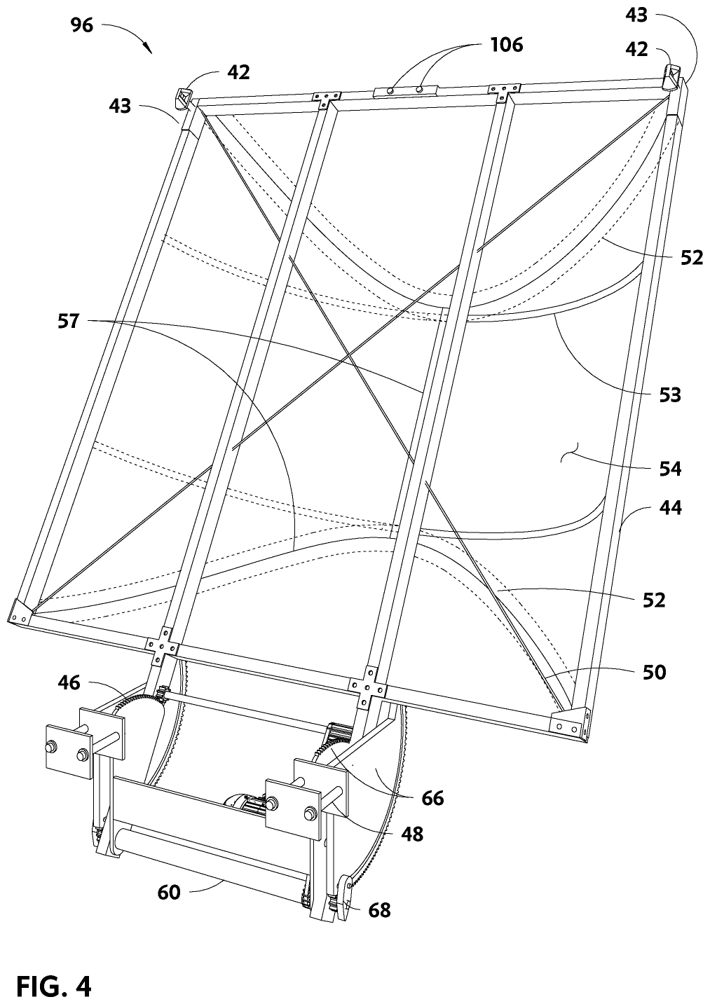

FIG. 4 An isolated perspective view of the container side of a tilt fairing shown in the open position.

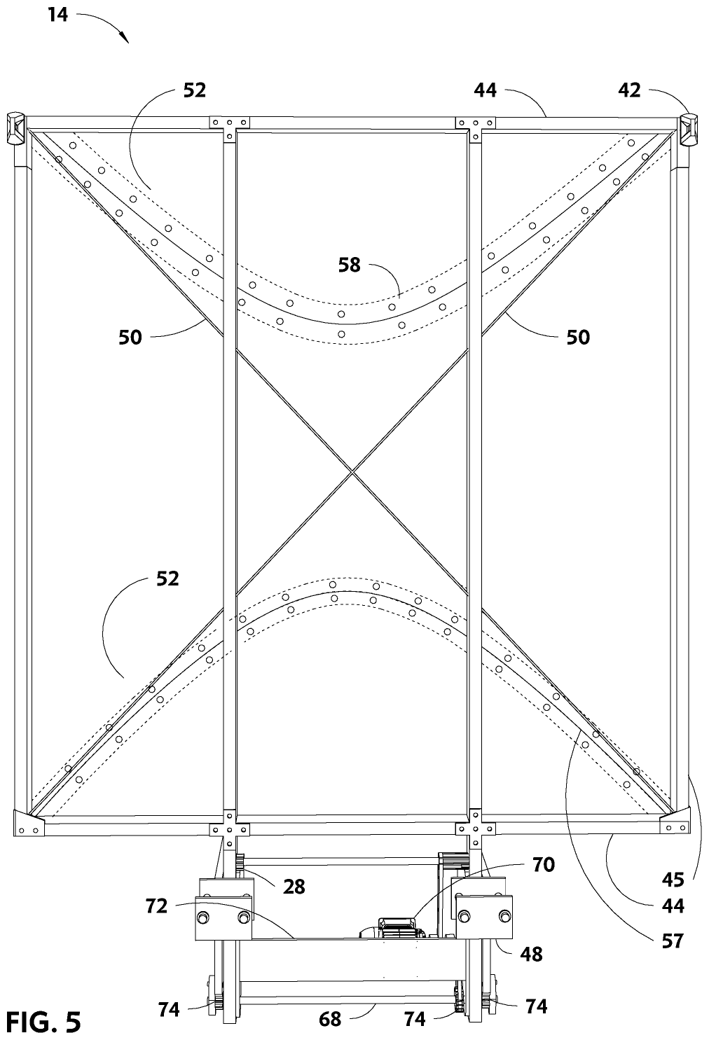

FIG. 5 An isolated quasi-elevation view of the container side of a tilt fairing.

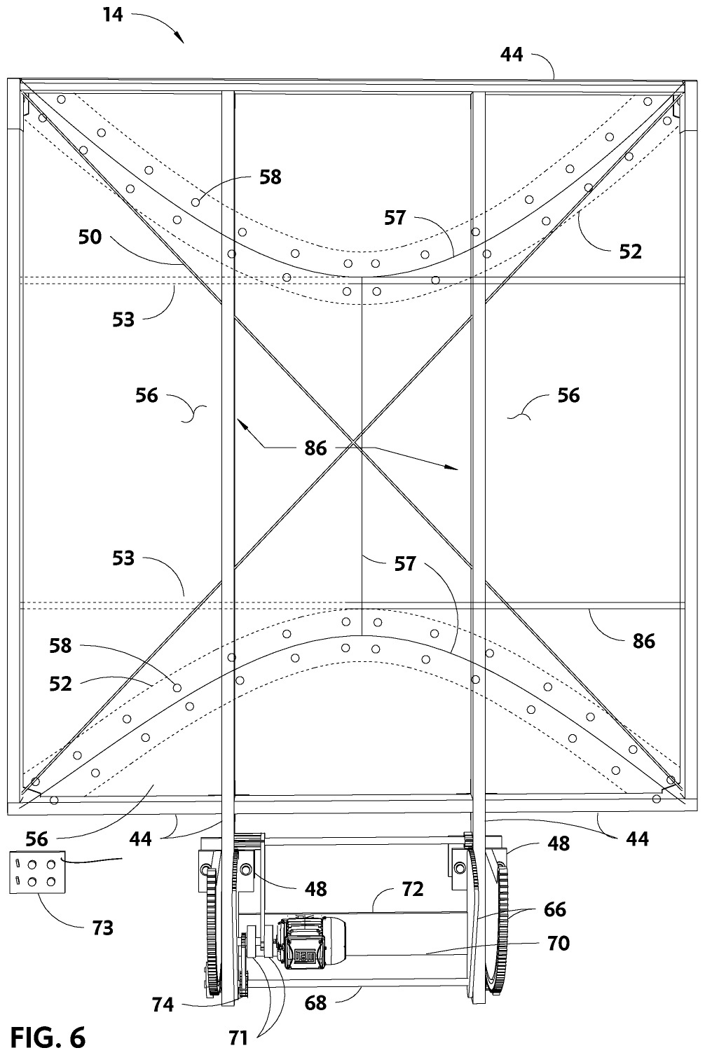

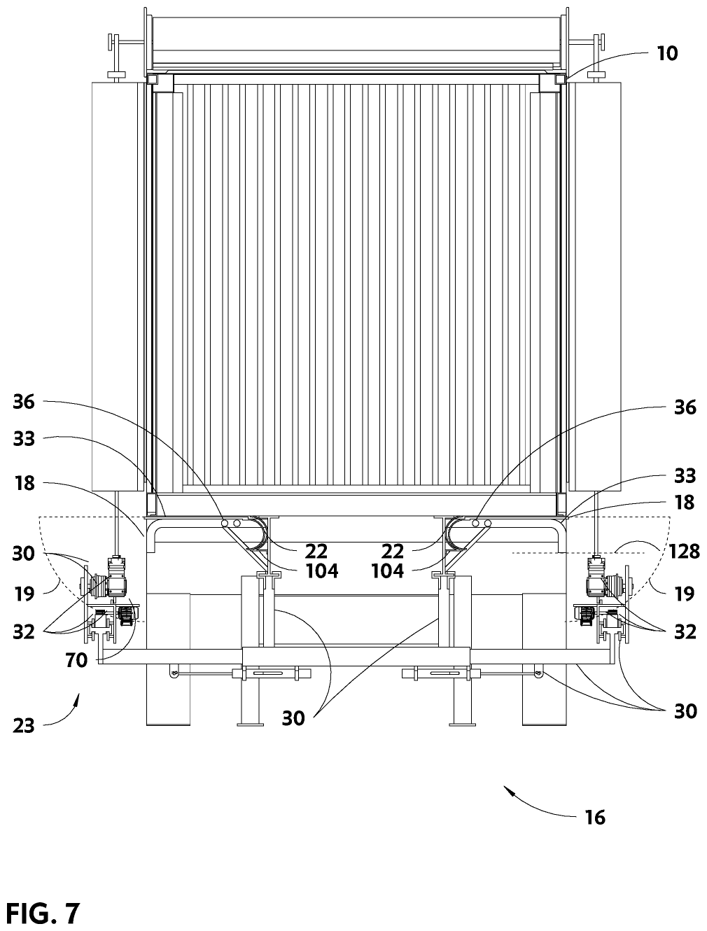

FIG. 6 An isolated rear quasi-elevation view of the tilt fairing. FIG. 7A section of an intermodal chassis with roll up skirt mechanisms and extending/retracting means for the pliable membrane applicator.

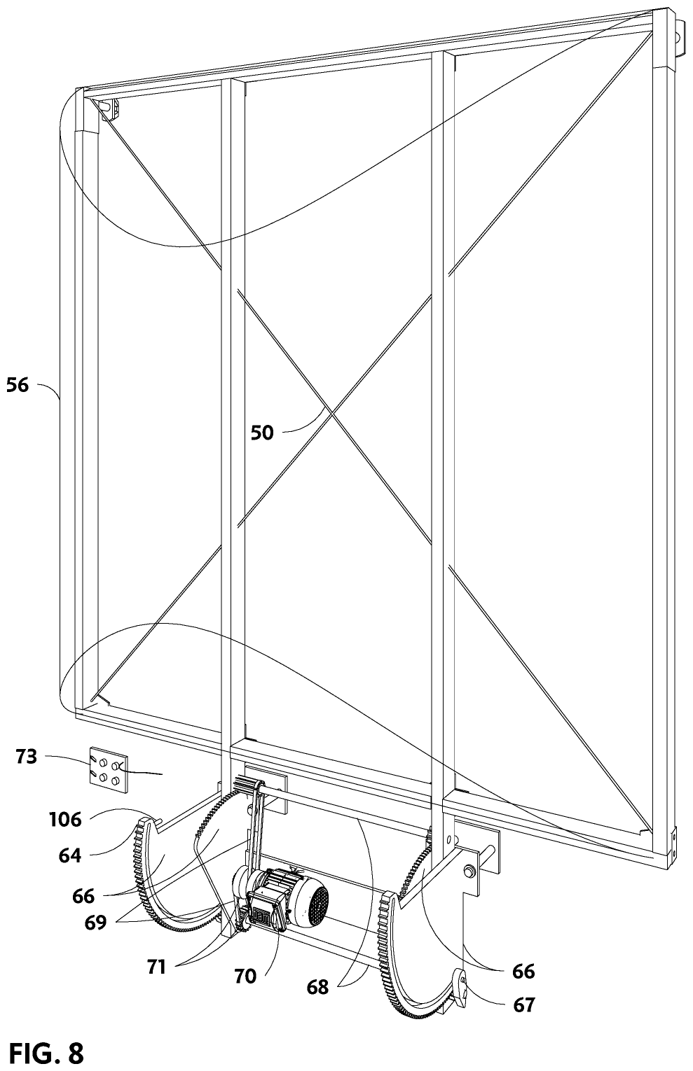

FIG. 8 An isolated perspective view of a rear side of a tilt fairing in upright position.

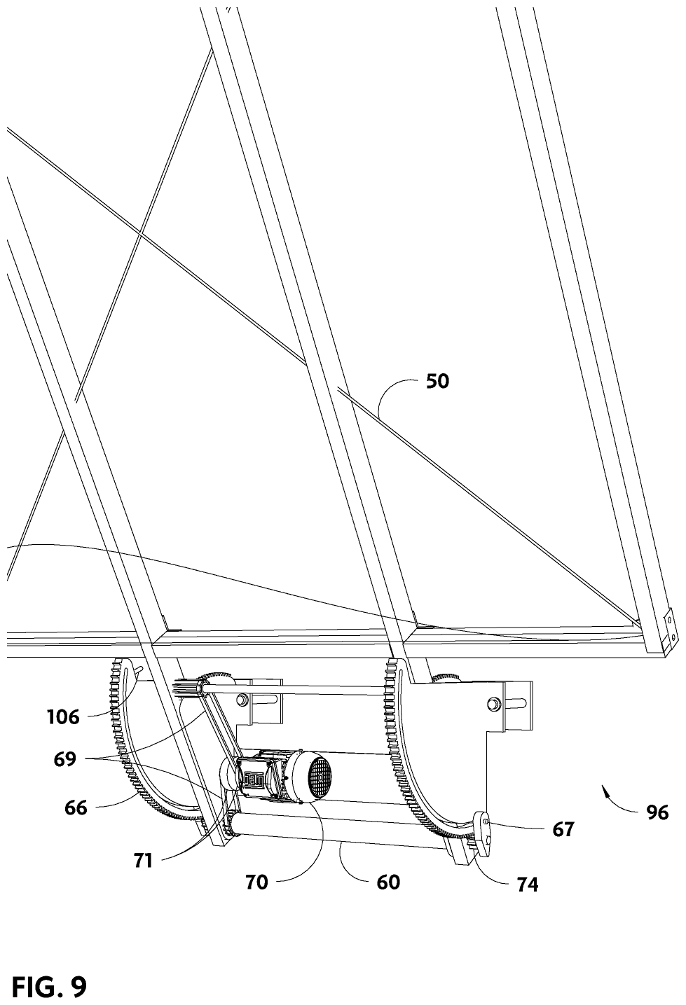

FIG. 9 An enlarged, isolated perspective view of a rear side of a tilt fairing in open position.

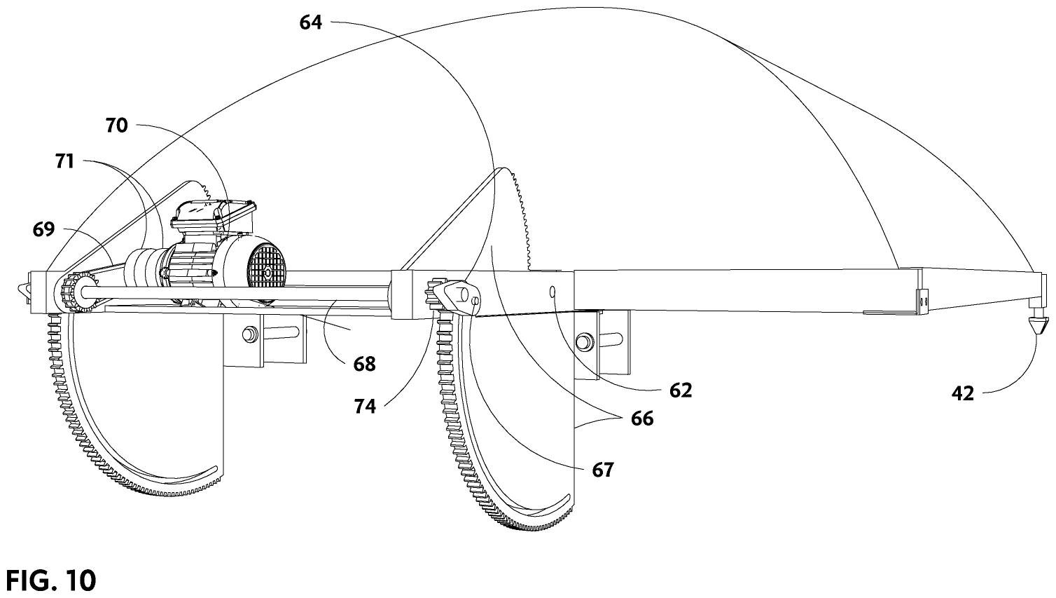

FIG. 10 An isolated perspective view of a rear side of a tilt fairing in prone position.

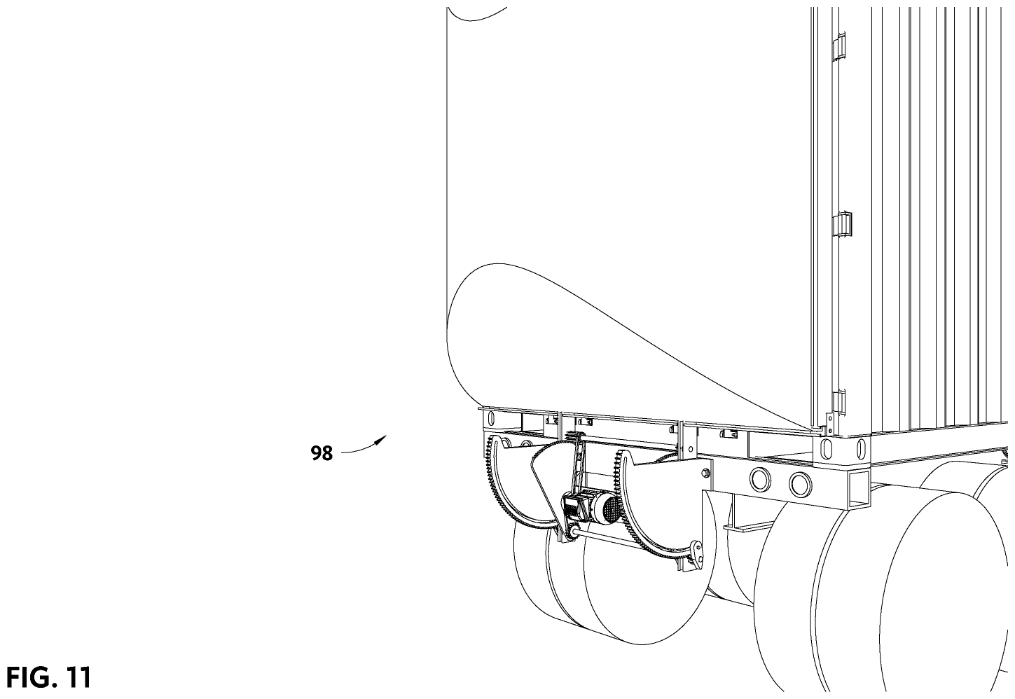

FIG. 11 An enlarged perspective view of a rear side of a tilt fairing in upright position on an intermodal chassis.

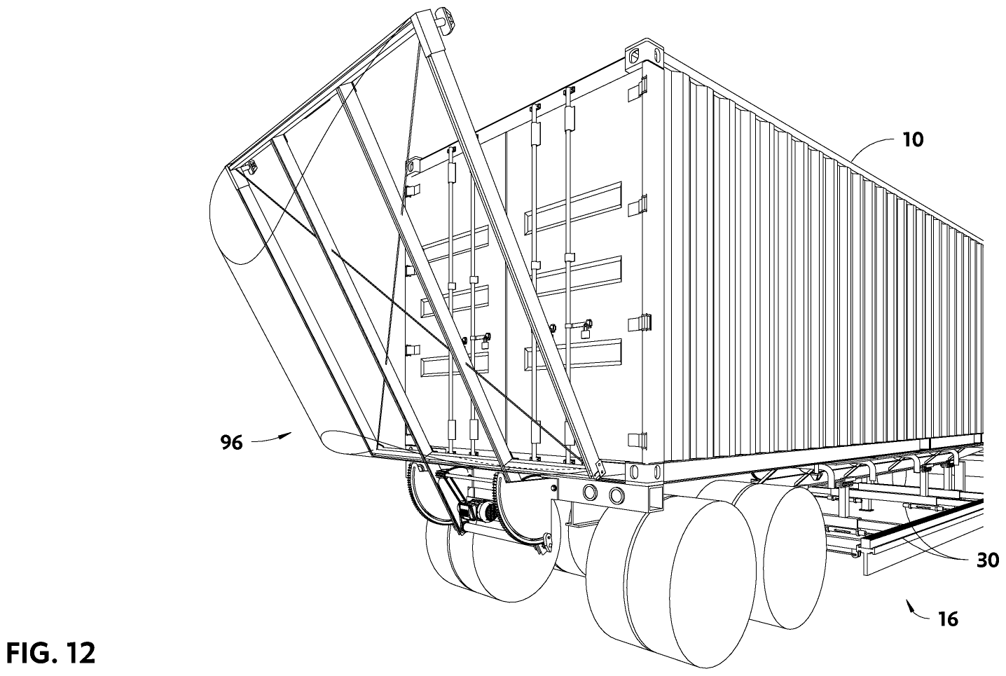

FIG. 12A perspective rear view of a tilt fairing in open position on an intermodal chassis.

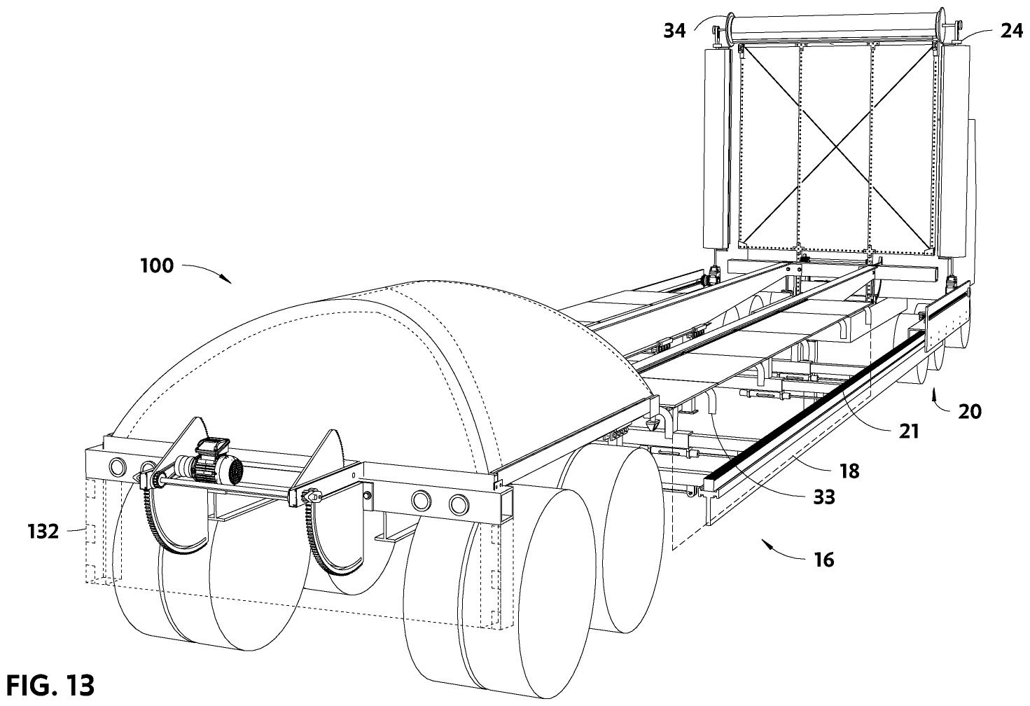

FIG. 13A perspective rear view of a tilt fairing in prone position on an intermodal chassis.

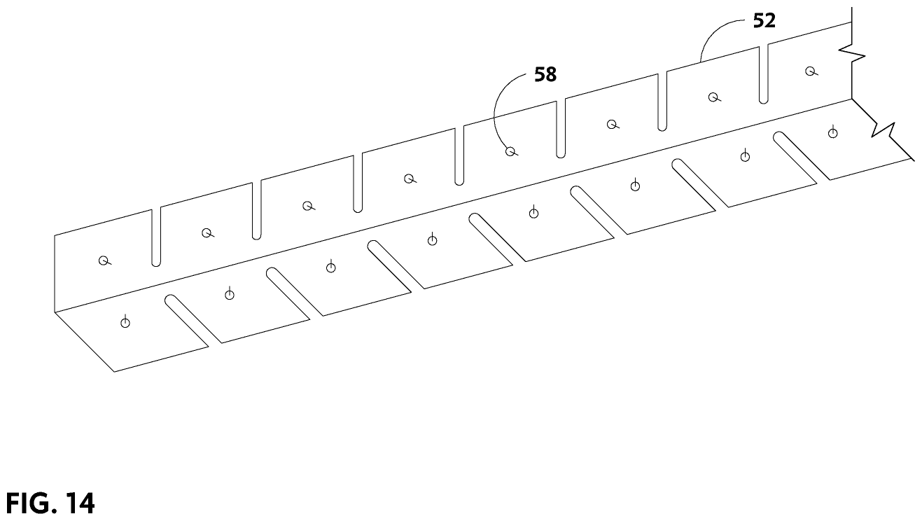

FIG. 14A perspective view of a fairing panel corner reinforcement strip.

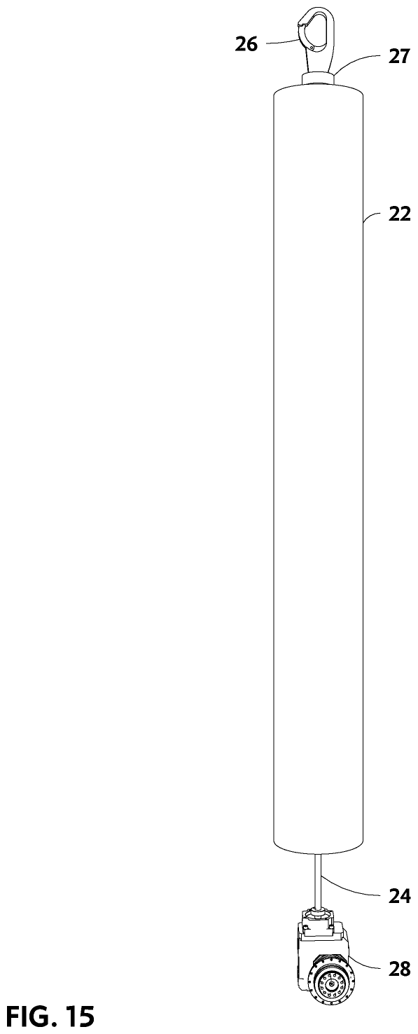

FIG. 15A perspective view of a motor and rotating spindle that applies a pliable membrane to a container side.

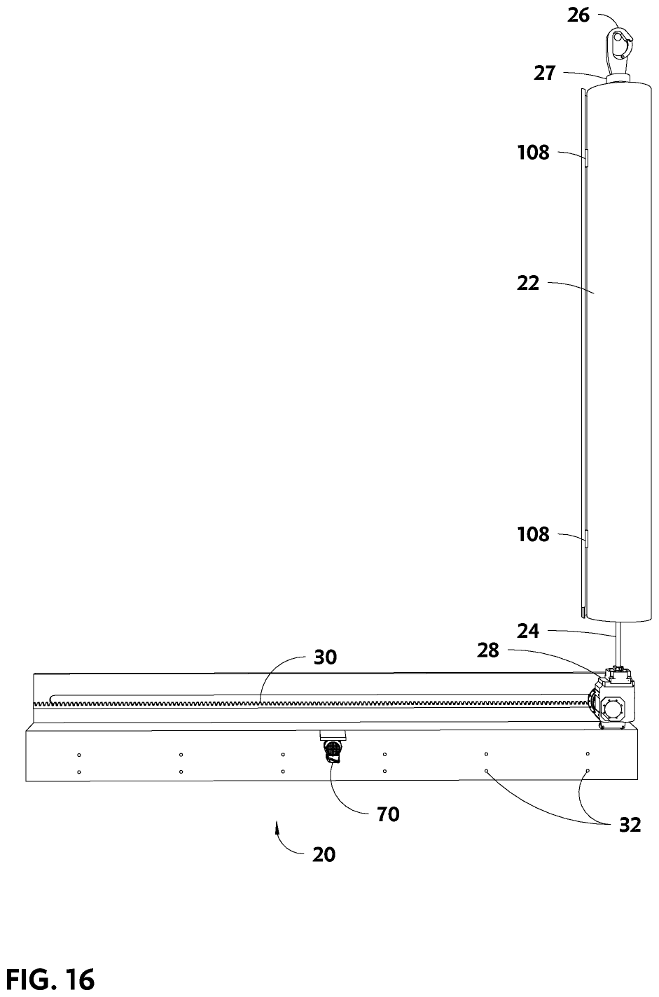

FIG. 16A perspective inside view of a rotating spindle that applies a skin to a container with a rolling apparatus for traversing the length of a container side.

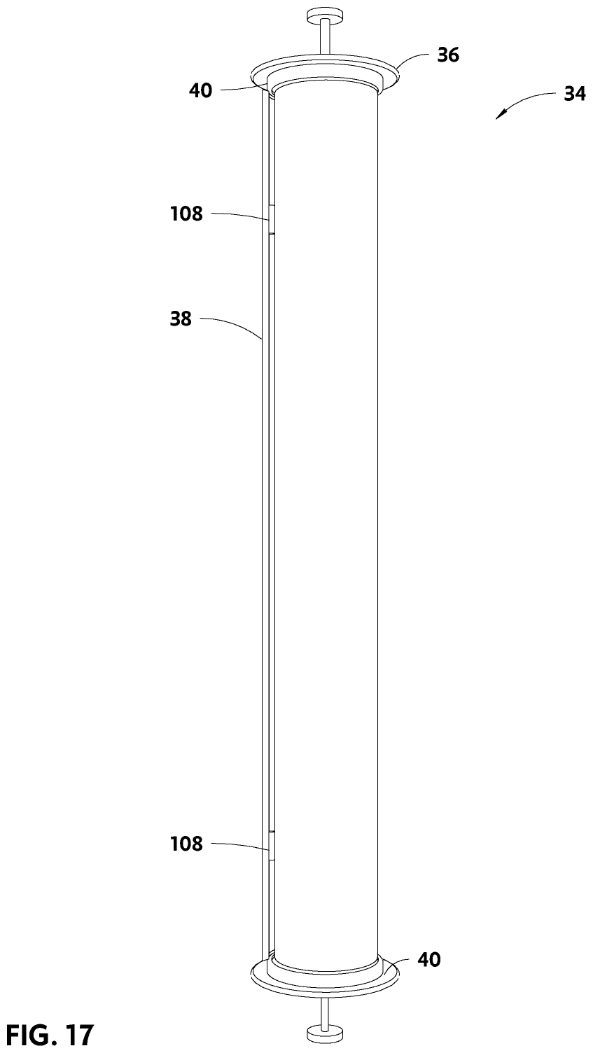

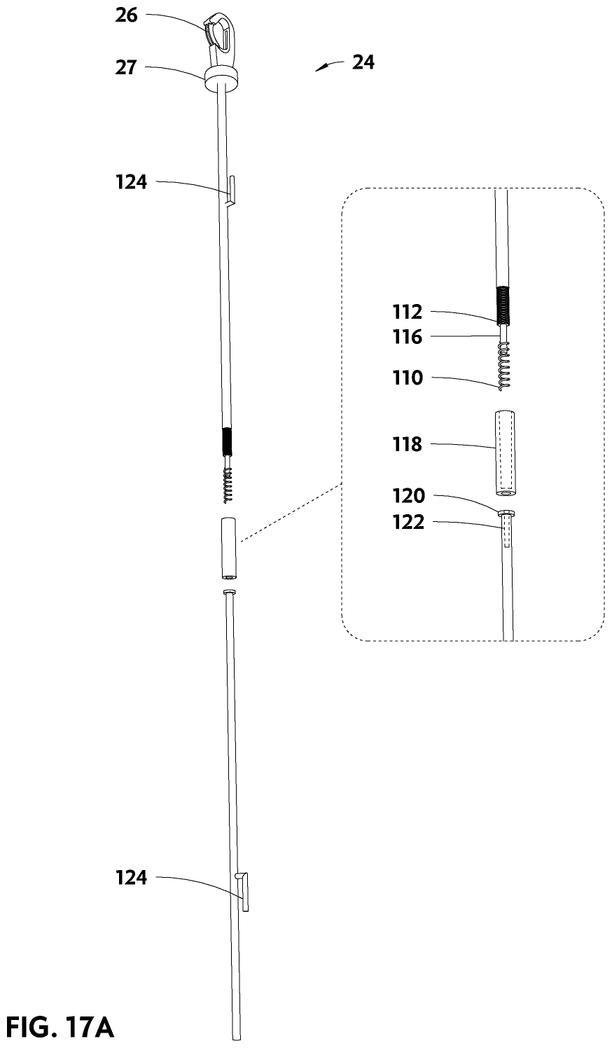

FIG. 17 An enlarged, isolated perspective view of a rotating top spindle that applies a skin to a container topside with a rolling apparatus for traversing the length of a container top side.

FIG. 17A An enlarged, exploded view of a spindle.

### Description of Embodiments

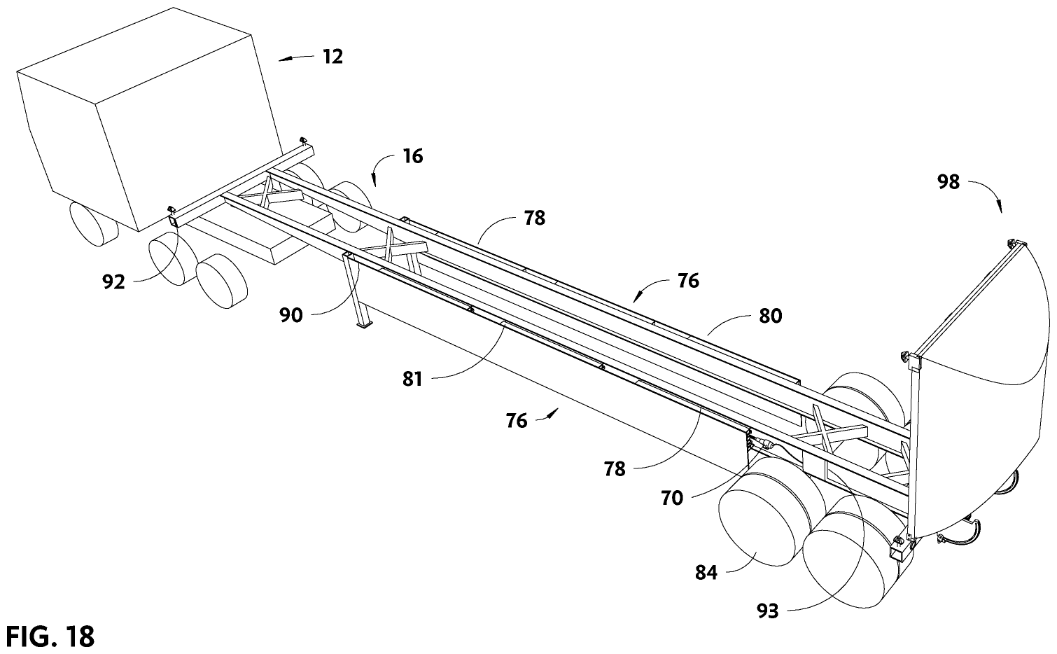

FIG. 18A perspective view of a semi-truck, tilt fairing and intermodal chassis with a collapsible skirt in closed position.

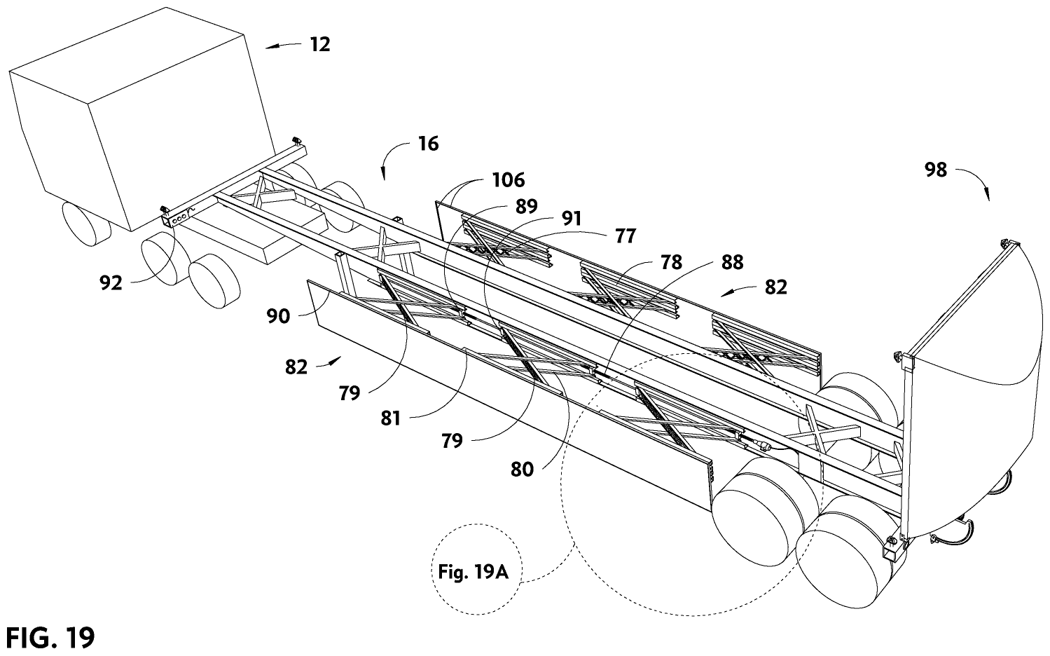

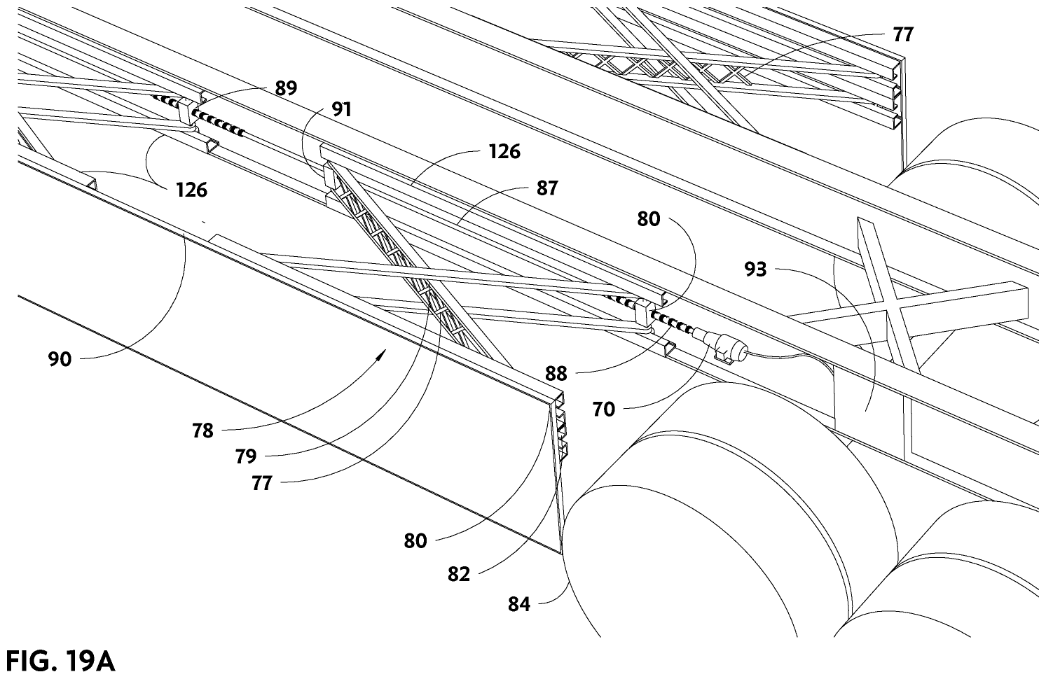

FIG. 19A perspective view of a semi-truck, tilt fairing and intermodal chassis with a collapsible skirt in open position.

FIG. 19A An enlarged perspective view of FIG. 19.

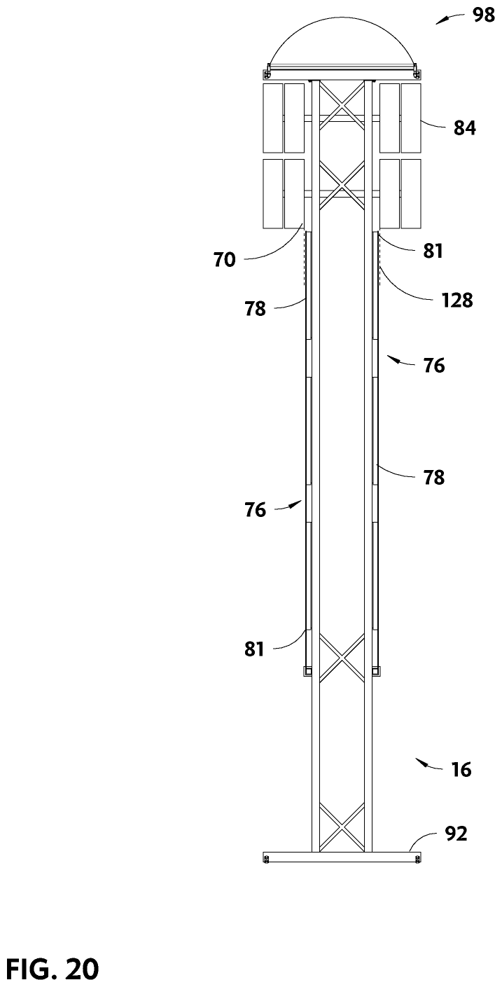

FIG. 20A plan view of a semi-truck, tilt fairing and intermodal chassis with a collapsible skirt in upright position.

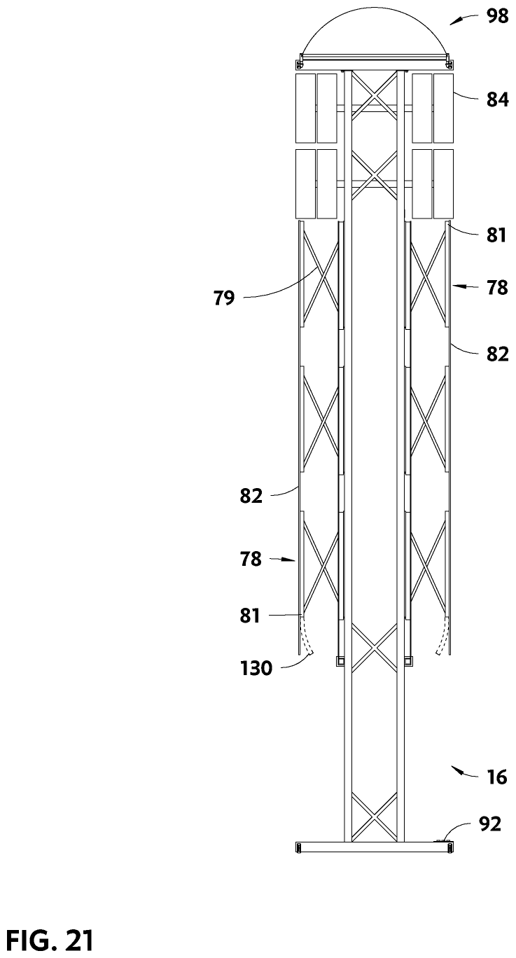

FIG. 21A plan view of a semi-truck, tilt fairing and intermodal chassis with a collapsible skirt in upright position.

### DETAILED DESCRIPTION

### Best Mode for Carrying Out the Invention

At this time, Jan. 1, 2023, I have had discussions with both the United States Environmental Protection Agency (EPA) and the California Air Resources Board (CARB). Surprisingly, both agencies have declined to work with me to analyze my series 1 freight container invention PCT/US22/038959-AERODYNAMIC APPARATUS FOR SERIES 1 FREIGHT CONTAINERS for approval as an aerodynamic device or to initiate regulation surrounding the emissions caused by steel flutes on the shipping container when used in transit. In one embodiment, this device welds thin flat sheets of weathering steel to the sides of the container for a diesel fuel savings of approximately 5.2%.

Based on this experience I feel both agencies are paralyzed when faced with disruptive innovation. Or perhaps they have shared my innovation with industry and received push back from inflexible corporate entities.

Either way my opinion of them as “saviors of our earth” has been diminished.

My aforementioned device will have an outsized impact on global trade. What that device did for me was illuminate how much the intermodal chassis has to gain. Thus I have created an entirely new category of intermodal trailer devices to which the United States government will have to adapt.

The current state of intermodal chassis with regards to emissions and aerodynamics is non-existent. One of the chief problems with the intermodal chassis is that they must be daily loaded and unloaded with shipping containers. This is unlike a semi-truck and trailer where permanent fixed fairings may be utilized for improved aerodynamics.

Intermodal chassis must also be stacked at ports to conserve space. Both stacking, loading and unloading create opportunities for great damage to fairings and is what I believe has prevented any innovation in this space. It appears no one has thought of different ways of accomplishing aerodynamics, emissions reduction and storage.

### —Original Message—

On Friday, Aug. 19, 2022 at 12:26 PM, Hawkins, Julie wrote:
Dear Mr. Pan,
I have tried to call you today around 2 μm and I'm now following up with an email. Could you explain a bit more as to what your device does? This is for sea containers? Your prior email was sent to the SmartWay Technology group and we only focus on technologies for the 53′ trailer, not sea containers or other trailer types. Thank you,
Julie Hawkins
Julie Hawkins
Environmental Engineer
Environmental Protection Agency
Office of Air Quality and Transportation
Washington, DC

### —Original Message—

Friday, Aug. 19, 2022 at 12:57 PM
Hi Julie,
Great to hear back.
Here's my widget! This is the CFD analysis, it was included in the patent application.
This is what I would call a category creator. Would the SmartWay Technology Group consider adding a new category?
If not, then perhaps you know of a different agency that could help certify?
Thank you,
Trevor

Above was the last correspondence with Julie at the EPA. She did not reply to my response. Below is the last correspondence with Mitzi Magtoto at CARB.

### —Original Message—

Tuesday, Nov. 1, 2022 at 11:05 AM
Hi Trevor,
To clarify, the intermodal chassis/container chassis is already included in the Phase 2 GHG category unfortunately the requirements are designed based standards i.e., installing low rolling resistance tires and tire pressure systems. We may amend the Phase 2 but container chassis requirements may remain the same but as mentioned since you are in our email list, you'll be notified on any updates and may provide comments on the rulemaking once it is open to public. I'm part of the Phase 2/3 reg team and we'll keep your product in mind as we develop/amend our regulations.
Regarding the US EPA contact, unfortunately I can't share them outside CARB. You can probably ask your US EPA Smartway contact.
Best regards,
Mitzi

FIG. 1A side front view of a prior art semi-truck 12 and intermodal chassis 16 with a series 1 freight container 14. Tilt fairings 14, roll-down skirts 18 and a pliable membrane applicator 23 are also depicted.

The idea here is to use my previously filed “pliable membrane” invention PCT/US22/038959 with newly invented apparatus to achieve a combined improvement in fuel efficiency. The pliable membranes yields a 5.2% diesel fuel savings, I expect the rear tilt fairing to yield in the 5-7% range, the front tilt fairing may yield 3-5% and the skirt could yield anywhere from 5-12%. This would be a maximum combined fuel efficiency of 31.2%, versus a standard series 1 freight container and prior art chassis.

Roll-down skirts 18 may retract to enable the pliable membrane applicator 23 to extend from the chassis beams 17. The rack and pinion rolling guide 20 will roll from the center of the chassis to each end of the container. A motor 70 rotates from a prone position to an upright position. The open position is depicted here.

A top spindle and pliable membrane 34 are set above the container where the spindle connections 26 may be made; this may be a carabineer, a latch, or a male/female connection. The cantilevered rack and pinion rolling guides 20 will roll across the container applying the pliable membrane 22 to a top side, and two sides of the series 1 freight container 10. After applying the pliable membranes 22 the process will reverse with the empty spindles.

FIG. 1A A modified tilt fairing 14 will house the top spindle and pliable membrane 34 in an empty or full state. A spindle connection 26 allows the top spindle and pliable membrane 34 to lock in place on the tilt fairing 14; carabineers, latches, and male/female connections may be used.

FIG. 2A side rear view of a prior art semi-truck 12 and intermodal chassis 16 with a series 1 freight container 10. Tilt fairings 14, roll-down skirts 18 and a pliable membrane applicator are also depicted.

This fig largely follows FIG. 1.

At the rear of the intermodal chassis 16 is a tilt fairing 14. The tilt fairing 14 is structurally attached to the intermodal chassis and may operate in three different positions. When in its upright position the tilt fairing will engage with the side corner castings 11 with a pair of twist locks 42. These may be manual or electrically actuated.

FIG. 3A section view of a tilt fairing 14 at the rear of an intermodal chassis 16, the container is not shown for clarity. Also shown are the various positions the tilt fairing 14 may operate in: open position 96, upright position 98, and prone position 100.

The tilt fairing 14 is bolted to an intermodal chassis beam 17; however, welding, clips, and other fasteners capable of handling the loads are an acceptable means for connection. A counterweight 60 is used to reduce the moment loads imposed on the motor. The counterweight 60 is approximately 2′-0″ from the pivot point 62 to provide some leverage, therein reducing the strain on the motor.

In the open position the tilt fairing 14 provides about 15″ of clearance from the edge of a side of a series 1 freight container 10. This will allow the container spreader operator some slack when lowering or lifting a container onto the intermodal chassis 16. The geared arc plates 66 have a flat portion so a container end does not lodge itself between the chassis and the tilt fairing.

In the upright position a twist lock 42 and twist lock actuator assembly 43 enable the tilt fairing 14 to lock to a series 1 freight container 10 corner casting 11. In this manner the tilt fairing 14 can remain affixed during transit; this occurs at both upper corner castings.

In the prone position a protruding arc structure 64 allows the tilt fairing 14 to pivot at pivot point 62. If these protruding arc structures 64 are not provided on the arc plates 66, then the framing 54 sticks up or angles above the plane of the chassis beams 17.

The protruding arc structures 64 can provide a tripping hazard in another embodiment where the tilt fairings 14 open up like a door. By hinging the entire tilt fairing 14 on a side, a steel support plate can swing the tilt fairing about 270 degrees away from the face of the doors.

This feature enables keeping a series 1 freight container 10 loaded on an intermodal chassis at a warehouse dock. A locking mechanism is needed to set the tilt fairing in place for transit. The steel hinged tilt fairing support 132 generally takes on the profile of the end of the chassis with openings for taillights, tilt fairings, license plates, etc. are provided. The end plate has sufficient structure to support the tilt fairing 14.

FIG. 4 An isolated perspective of the container side of a tilt fairing 14 shown in the open position.

Tilt fairing 14 framing 44 is sized and adapted to match an end of a series 1 freight container 10. The pliable fairing material 54 may be connected to the tilt fairing framing 44 and connected with a pliable angle strip 52. As few as three pieces of pliable fairing material 54 may be used such as, a curved hourglass piece and two rounded V-shaped pieces.

This embodiment utilizes extruded male/female strips 53 which allows for folding. A male strip of the top side of one pliable fairing material 54, and a female strip on the bottom side of a pliable fairing material 54 are contemplated. Hook and loop, buttons and zippers may also be used in the pliable angle strip 52.

Arc plates 66 are structurally attached to the connection means of the intermodal chassis 48 and enable the fairing to rotate and assume three positions: open, upright and prone. A counterweight 60 is shown integrally attached to a drive axle 68. Stop pressure buttons 106 halt the motor. While the buttons are shown at a top side of the frame 44 they may be placed in other convenient locations as required.

FIG. 5 An isolated elevation view of the container side of a tilt fairing 14 largely follows FIG. 4. A motor 70 is shown connecting to the drive axle 68 where no integral counterweight 60 is shown. However, the motor mounting plate 72 and motor 70 should also be considered when engineering the counterweight necessary to reduce the moment loads the motor must overcome. Vertical frame members 45 may be used to perfectly align with the edges of the series 1 freight container. No extruded male/female strips 53 are shown in this embodiment. This embodiment shows a non-folding version pliable fairing material 54.

FIG. 6 An isolated rear elevation view of the tilt fairing 14 shows an area for advertising panel slots 86.

The motor 70 and motor mounting plate 72 are placed so two electromagnetic clutches 71 may operate two different gears 74, enabling the various positions required of the tilt fairing 14 to operate. These electromagnetic clutches are operated by a button and switch actuator system 73.

Pliable angle strips 52 allow the three sheets of pliable fairing material 56 to form the convex shapes. However, hook and loop, buttons, zippers and similar tools may accomplish the same job.

The drive axle 68 connects to two membranes of the frame 44. A control actuator 73 has two switches, and each switch has a forward and rearward button. In this way, one motor can drive both gears 74 connected to two electromagnetic clutches 71 and enable movement on both arc plates 66. The button and switch actuator system 73 may be placed where most convenient and out of the way of tilt fairing 14's movements.

FIG. 7A section of a series 1 freight container 10 on an intermodal chassis 16 with roll-up skirts 18 and extending/retracting means 30 for the pliable membrane applicator 23. The roll-up skirt 18 has two guide rollers 36 mounted in a J-shaped guide channel 33 having a C-shaped profile to allow guide rollers 36 to operate. At an upper portion of the roll-up skirt 18 a pliable membrane 22 is attached. This allows a full-sized skirt to block wind and roll at the chassis 16 in an arched baffle 104.

The pliable membrane 22 is notched at the J-shaped guide channel 33 to enable curling, or bonding in the arced baffle 104.

At rear corners of intermodal chassis 16 the frame 44 may need to notch around twist locks as required for clearance.

Just as pliable membrane applicator 23 extends outward, the support may be aligned to the side of the chassis beams 17. In this manner, the overall pliable membrane applicator may both lower, and rise to give greater clearance in transit, as some driver routes may have less flat terrain to traverse.

Extending/retracting means 30 may be placed in any advantageous position. The current placement is to demonstrate the concept.

As I prepare to file this application, I can see a radius track having a rack could also provide support and rotation. There is nothing sacred about the exact arrangement here shown. Radial movement and support is what solves the problem.

FIG. 8 An isolated perspective of a rear side of a tilt fairing 14. Geared arc plates 66 enable the rear tilt and forward tilt motions.

The motor 70 drives chains, or belts 69 to the drive axles 68. A clutch like system or multi-gear apparatus engages either the upper drive axle 68 or the lower drive axle 68. Two electromagnetic clutches 71 can accomplish this. Other means that utilize one motor are acceptable. Stop pressure buttons 106 halt the motor; they may be placed at convenient locations as required-meaning, they do not have to be placed exactly where shown.

Extruded male and female strips 53 are placed both above and below pliable fairing material 56. This material is pliable but stiff enough to prevent tight rolls.

This allows the panels to slip into a secured flat position and the extruded male/female strips keeps them aligned. The pliable fairing material 54 is shown translucent for diagrammatic purposes.

A support pin and shackle 67 support the tilt fairing 14. Where a support slot 66 is shown, other tracks mounted to the outside of the geared arc plate 66 would also work.

FIG. 9 An enlarged, isolated perspective view of a rear side of a tilt fairing 14. This fig is largely the same as the previous fig but shows greater detail.

FIG. 10 An isolated perspective view of a rear side of a tilt fairing 14 in prone position. Pivot point 62 locks in place with geared 74 and geared arc plate rack 66 allowing the lower drive axle 68 to rotate around the larger geared arc plates 66 to enable the prone position as shown in this fig. The stop pressure buttons 106 prevent the motor from exceeding the available protruding arc structure 64.

FIG. 11 An enlarged perspective view of a rear side of a tilt fairing 98 on an intermodal chassis 16 in an upright position mounted to a series 1 freight container 10.

FIG. 12A perspective rear view of a tilt fairing 96 in an open position on an intermodal chassis 16 and mounted to a series 1 freight container 10.

FIG. 13A perspective rear view of a tilt fairing 100 in prone position on an intermodal chassis 16. This position prevents the fairing from becoming a parachute when the semi-truck 12 is driving empty.

A better view of how the roll-up skirts 18 work is shown here. The rack and pinion rolling guide 20 is shown in a cantilevered, extended state with the top spindle and pliable membrane 34 connected to the counterpart top pliable membrane applicator 23.

The roll-up skirts 18 may extend the entire opening. This image is diagrammatic. A further plurality of J-shaped guide channels 33 would be required for full length applications.

The pliable membrane 22 allows for bending along the arced baffle 104. In this way a full skirt can be used where pliable membrane applicator 23 would prevent folding or bending. The J-shaped guide channels 33 can be welded or mechanically fastened to the chassis beam.

FIG. 14A perspective view of a pliable fairing panel 56 pliable corner reinforcement strip 52. The notches in the strip allow the panels to bind together easily along a parabolic geometry with mechanical fasteners 58. However, hook and loop, buttons, and zippers can also be used in lieu of mechanical fasteners, and perhaps even the pliable corner reinforcement strip 52 itself.

FIG. 15A perspective view of a rotating spindle 24 that applies a pliable membrane 22 to a container side. A spindle connection 26 enables the top spindle and side spindle to connect and roll as a unit with the rack and pinion rolling guide 20. The swivel bearing prevents the spindle connection 26 from rotating the top spindle 34.

A drive gear 28 enables rotation of the spindle from a prone to an upright position, as well as spinning, or rolling the rotating spindle, and extending or retracting along the rack and pinion rolling guide 20.

FIG. 16A perspective view of a rotating spindle 24 that applies a pliable membrane 22 to a series 1 freight container 10 with a rolling apparatus (rack and pinion rolling guide 20) for traversing the length of a container side.

The extending/retracting means 30 allows the drive gear 28 to pull or push along an axis. Rollers 32 enable the rack and pinion rolling guide 20 to cantilever off of the extending retracting means 30 which are mounted to the chassis beams 17. A motor 70 with pinion, drives the rack and pinion rolling guide 20.

FIG. 17 An enlarged, isolated perspective view of a rotating top spindle and pliable membrane 34 that applies a skin to a container with a rolling apparatus for traversing the length of a container top side.

Guide rollers 36 prevent the spindle from walking off to one side and rubber rolling surface 40 allows gripping of a top side of a series 1 freight container 10.

The wind seal 38 has spooling slots 108 for a connection means to a pliable membrane 22 edge.

FIG. 17A An exploded view of a spindle 24. An upper portion of the spindle has a spindle connection 26 which may clip to a spindle 24 of a top pliable membrane 22. The spindle connection should fit as tightly as possible. Carabiner, latches and male/female type connections that do not slip are preferred. The carabiner as shown is purely diagrammatic only. Rubber or other materials may enable better gripping. The spindle 24 has two sections. A lower section that connects to a motor 70. On the upper end of the lower section is a thickened end 120 allows the coupler 118 to rotate.

The coupler 118 has a threaded female end 114 that mates with threaded end 112 of the upper section of spindle 24. Being hollow allows springs 110 to flex. The spring 110 loosely surrounds guide rod 116 and is longer than the coupler 118 so that a female guide slot 122 may accept the guide rod 116.

In this way, the spindle may be compressed so that spooling hooks 124 may enter the spooling slots in wind seal 108. This then secures the edge of the pliable membrane 22 for skinning the series 1 freight container 10, or de-skinning the container.

### DESCRIPTION OF EMBODIMENTS

FIG. 18A perspective view of a semi-truck 12, tilt fairing 14 and intermodal chassis 16 with a collapsible skirt in closed position 76.

The skirt in closed position 76 enables stacking of other intermodal chassis 16 without damage to the skirts. The skirts may also be tucked away to prevent damage when an intermodal chassis 16 is driving empty.

A tilt fairing 14 is shown here to demonstrate how the skirts can work together for maximum fuel efficiency-if a customer desires. Albeit, this combination does not include skins on the container. The pliable membranes 22 and series 1 freight containers 10 are omitted for clarity but also will factor in to the maximum fuel efficiency so that there are 3 elements working together: front and rear tilt fairings 14, and collapsible skirts in open position 82.

Collapsible bracing 78 will be structurally mounted to the chassis beams 17 and is outfitted with locking mechanisms 81 to stow away or travel safely, these can be latches, pins, etc. . . . this embodiment would not have an electric motor to open or close the collapsible bracing. A hand tool could be used to rotate the drive rod 87.

Thinner collapsible bracing could be utilized than shown here to completely tuck away the structure in the web of the chassis beams 17. This is diagrammatic.

FIG. 19A perspective view of a semi-truck 12, tilt fairing 14 and intermodal chassis 16 with a collapsible skirt in open position 82. This fig largely follows the previous one.

FIG. 19A Motor 70 may be connected to a battery 93, the semi-truck electrical system, or a combination of both. Worm drive rack, and pinion are also acceptable means for extending/retracting.

The motor 70 rotates the drive rod 87 that has several threaded rod 88 sections. This Moves one end of the collapsible bracing 78 as the drive rod 87 rotates, similar to a carjack. Inner collapsible braces 80 have a vertical axle matching a threaded section to mate with the threaded rod 88 portions of the drive rod 87, there are rollers 32 on the ends of the vertical axle to enable smooth movement.

Outer collapsible bracing 79 are stationary at the vertical axle, but there is a journaled portion without threads 91, having bearings. In this way, the drive rod 87 may rotate freely. Truss chords 77 may be used in the inner collapsible brace 79. This provides extra rigidity. They are placed to not interfere with drive rod 87. Further, they may be reduced toward the collapsible skirt 82 so when stowed away they do not interfere with roller guides 126.

FIG. 20A plan view of a tilt fairing 14 and intermodal chassis 16 with a collapsible skirt in closed position 76. The collapsible bracing 78 is shown and may be locked with the locking mechanism 80. Further, where the motor 70 and drive rod 87 are used the threaded rod 88 provides a lock. When convenient a stop pressure button 106 may be used to automatically halt the motor 70 to prevent the threaded rod 88 sections from stripping. Clearance lines 128 show the chassis 16 may be stacked. Some adjustment will be required for different intermodal chassis 16 models, and brands. In some cases, as previously mentioned, the collapsible bracing will be tucked into the chassis beams 17.

FIG. 21A plan view of a semi-truck 12, tilt fairing 14 and intermodal chassis 16 with a collapsible skirt in open position 82. The collapsible bracing 78 is shown and may be locked with the locking mechanism 81. Chassis wheels 84 show the rear end of the intermodal chassis 16.

Bent or curved ends 130 may be utilized for deflection as necessary.

### REFERENCE SIGNS LIST—(NUMBERS ARE BOLDED IN DESCRIPTION)

10 series 1 freight container
11 corner casting
12 semi-truck
14 tilt fairing
15 tilt faring, with spindle connection, and aerodynamic extension
16 intermodal chassis
17 chassis beam
18 roll-up skirt
19 arc pattern of roll up skirt
20 rack and pinion rolling guide
21 rack and pinion
22 pliable membrane
23 pliable membrane applicator
24 spindle
26 spindle connection; carabineer, latch, male/female
27 swivel bearing
28 drive gear
30 extending/retracting means; hydraulic pistons, rack and pinion, ect. . . .
31 cantilever guide plate
32 rollers
33 J-shaped guide channel
34 top spindle and pliable membrane
36 guide roller
38 wind seal
40 rubber rolling surface
42 twist lock
43 twist lock actuator assembly
44 frame
45 vertical frame member; to align flush with edges of a container
46 rotating guide slot

### REFERENCE SIGNS LIST—CONTINUED (NUMBERS ARE BOLDED IN DESCRIPTION)

48 connection means to existing intermodal chassis
50 bracing rods
52 pliable fairing panel corner reinforcing strip
53 extruded male/female strips
54 fairing framing
56 pliable fairing material
57 joint in pliable fairing material
58 mechanical fastener
60 counterweight, encases drive axle
62 pivot point
64 protruding arc structure
66 geared arc plate; with support slot
67 support slot pin/roller bearings and shackle
68 drive axle
69 chain, or belt
70 motor
71 electromagnetic clutch
72 motor mounting plate
73 button and switch actuator system
74 gear
76 skirt in a closed position
77 truss chords
78 collapsible bracing
79 inner collapsible braces not connected enabling extending, and retracting
80 outer collapsible braces, vertical axles with bearings for rotation
81 locking mechanism
82 skirt in open position
84 chassis wheel
86 advertising panel slot
87 drive rod

### REFERENCE SIGNS LIST—CONTINUED (NUMBERS ARE BOLDED IN DESCRIPTION)

88 threaded rod
89 threaded portion on rollers
90 skirt stiffener; as required vertically horizontally
91 journaled portion without threads, bearings in place moved drive rod
92 button actuator system
93 battery
94 extension at edges it desired to match with edge of container
96 tilt fairing in open position
97 tilt fairing upright position
100 tilt fairing prone position
102 chassis clip
104 arced baffle
106 stop pressure button
108 spooling slot in wind seal
110 spring
112 threaded end
114 threaded female end
116 guide rod
118 coupler
120 thickened end
122 female guide slot (with spindle rod)
124 spooling hook
126 roller guides
128 clearance lines
130 bent, or curved ends
132 hinged tilt fairing support (to enable a container to remain on chassis and have freight added or removed, such as a warehouse, swings like a door, but provides same function as the fixed tile fairing)

### CITATION LIST

The following is a tabulation of some prior art that presently appears relevant.

### U.S. Patents

| Pat. No. | Kind Code | Issue Date | Patentee |
|---|---|---|---|
| U.S. Pat. No. 9,033,629 | B2 | 2015 May 19 | Payne |
| U.S. Pat. No. 6,279,295 | B1 | 2001 Aug. 28 | Girard et al. |
| U.S. Pat. No. 8,356,456 | B2 | 2013 Jan. 22 | Floding et al. |
| U.S. Pat. No. 8,534,033 | B2 | 2013 Jul. 17 | Perreault et al. |
| U.S. Pat. No. 5,463,841 | A | 1995 Nov. 07 | Hayakawa et al. |
| U.S. Pat. No. 6,322,127 | B1 | 2001 Nov. 27 | Masterson et al. |

### Foreign Patent Documents

| Foreign | | | App or |
|---|---|---|---|
| Doc. Num. | Kind Code | Issue Date | Pantentee |
| KR101355820 | B1 | 2014 Jan. 27 | [symbol] |
| CN113148275 | A | 2021 Jul. 23 | [symbol] [symbol] |
| | | | [symbol] [symbol] |
| | | | [symbol] |
| DE3918311 | C2 | 1997 Oct. 09 | Werner Uthoff |
| CN107089360 | A | 2017 Aug. 25 | [symbol] |
| CN201619510 | U | 2010 Nov. 03 | [symbol] [symbol] |

### Nonpatent Literature Documents

https://doi.org/10.1177/0954409713488101

I claim:

1. In the field of intermodal logistics a combination of a magnetic skin applicator, a tilt fairing, and a roll-up skirt comprising:
an intermodal chassis having both a left side, and a right side;
a tilt fairing comprising:
a structural frame having a generally rectilinear profile, when viewed in elevation view, sized and adapted to substantially cover an end of a series 1 freight container while mounted on said intermodal chassis,
a set of panels mechanically mounted to the outer edges of said structural frame therein preventing air from entering between said structural frame and said panels,
a plurality of twist locks mounted to a pair of top outer corners of said structural frame wherein the placement of the twist locks matches the upper corner castings of said series 1 freight container such that the tilt fairing may become locked to said series 1 freight container,
a means for rotation of said tilt fairing, mounted to said intermodal chassis, that allow said structural frame to both extend away from said series 1 freight container in an open state, and align flush to the end of said series 1 freight container in an upright state such that said plurality of twist locks may enable an apparatus to both place, and remove said series 1 freight container on said intermodal chassis,
further, said means for rotation also allow said tilt fairing to align to the intermodal chassis in a closed position;
a pair of roll-up skirts wherein each comprise:
a semi-rigid panel substantially filling a gap between a road, said series 1 freight container, a set of wheels on a semi-truck towing said intermodal chassis, and a set of wheels mounted to said intermodal chassis, wherein wind drag may be greatly reduced, and said semi-rigid panel is aligned to an outer edge of said series 1 freight container,
a pliable membrane forming a portion of the roll-up skirt, wherein the pliable membrane may fold to accommodate mechanical equipment bolted to said intermodal chassis,
a plurality of wheels attached to said semi-rigid panel,
a plurality of J-shaped guides having a C-shaped cross section that provide a place for said plurality of wheels to roll, in this manner the roll-up skirt may both retract, and roll down to an extended state, wherein aerodynamic improvements may be enjoyed,
further, said plurality of J-shaped guides each terminate adjacent an arced baffle having a U-shaped outer shell that enables said pliable membrane to fold without creasing, and said plurality of guides each have a vertical end enabling said plurality of wheels to stop and provide structure for said semi-rigid panel to remain vertical;
a magnetic pliable membrane applicator comprising:
a structural top spindle having a first plurality of fingers for both entering, and exiting a plurality of spooling slots formed on an edge of a magnetic skin, therein enabling the structural top spindle to grab hold of said edge of said magnetic skin to both roll, and unroll said magnetic skin,
further, each end of said structural top spindle has a means for rolling along a top side of said series 1 freight container,
a structural side spindle having a second plurality of fingers for both entering, and exiting a plurality of spooling slots formed on an edge of a magnetic skin, therein enabling the spindle to grab hold of said edge of said magnetic skin to both roll, and unroll said magnetic skin,
further, said structural spindle has a top end with a means for connecting to a top spindle that both rolls, and unrolls a top pliable membrane on a top side of said series 1 freight container,
a plurality of structural outriggers having a means for attaching to said intermodal chassis, a means for both extending to said outer edge of said intermodal chassis, and retracting therein enabling the pliable membrane applicator to be stowed away when not in use,
a means for telescoping at an end of each said plurality of structural outriggers, wherein said structural spindle may reach an end of said series 1 freight container, and an opposite end of said end wherein when retracted the means for telescoping may be stowed away when said plurality of structural outriggers are in a retracted stated,
in this manner, said means for telescoping do not snag on landing gear, and both front, and rear tires of said intermodal chassis,
a means for rotating said structural spindle from a prone position to an upright position mounted to said means for telescoping,
a means for rolling said structural spindle both from an end of said series 1 freight container to an opposite end, and from said opposite end to said end, therein enabling the magnetic skin to be both rolled, and unrolled from a side of said series 1 freight container,
assembled as such, a magnetic pliable membrane applicator is formed, and when in use a pair of said magnetic pliable membrane applicators are used, such that the spindle of each said pair of side applicators connect to said structural top spindle and enable applying a separate magnetic pliable membrane to a top side, a left side, and a right side of said series 1 freight container.

2. In the field of intermodal logistics a combination of a tilt fairing, and a pair of collapsible skirts comprising:
an intermodal chassis having both a left side, and a right side;
a tilt fairing comprising:
a structural frame having a generally rectilinear profile, when viewed in elevation view, sized and adapted to substantially covering an end of a series 1 freight container while mounted on said intermodal chassis,
a set of panels mechanically mounted to the outer edges of said structural frame therein preventing air from entering between said structural frame and said panels,
a plurality of twist locks mounted to a pair of top outer corners of said structural frame wherein the placement of the twist locks matches the upper corner castings of said series 1 freight container such that the tilt fairing may become locked to said series 1 freight container,
a means for rotation of said tilt fairing, mounted to said intermodal chassis, that allow said structural frame to both extend away from said series 1 freight container, and align flush to the end of said series 1 freight container such that said plurality of twist locks may enable an apparatus to both place, and remove said series 1 freight container on said intermodal chassis;
a pair of collapsible skirts mounted wherein each comprise:
a means for structural connection to said intermodal chassis,
a semi-rigid panel substantially filling a gap between a road, said series 1 freight container, a set of wheels on a semi-truck towing said intermodal chassis, and a set of wheels mounted to said intermodal chasses, wherein wind drag may be greatly reduced, and said semi-rigid panel is aligned to an outer edge of said series 1 freight container when in an extended state,
a plurality of collapsible braces comprising:
a plurality of structural frames having pivot points with a means for both extending away from said intermodal chassis, and retracting back to said intermodal chassis, therein having both said extended state, and a retracted state,
said plurality of structural frames are spaced to provide stiffness to said semi-rigid panel;
a motorized means for both extending, and retracting said semi-rigid panel from said intermodal chassis;
a portion of said plurality of collapsible braces, and a portion of said means for both extending, and retracting are connected to said means for structural connection on said left side of the intermodal chassis;
a portion of said plurality of collapsible braces, and a portion of said means for both extending and retracting are connected to said means for structural connection on said right side of the intermodal chassis;
in this manner, said intermodal chassis, said tilt fairing, and said pair of collapsible skirts form a combination.

3. In the field of intermodal logistics and tilt fairing comprising:
a structural frame having a generally rectilinear profile, when viewed in elevation view, sized and adapted to substantially cover an end of a series 1 freight container while mounted on said intermodal chassis;
a set of panels mechanically mounted to the outer edges of said structural frame therein preventing air from entering between said structural frame and said panels;
a plurality of twist locks mounted to a pair of top outer corners of said structural frame wherein the placement of the twist locks matches the upper corner castings of said series 1 freight container such that the tilt fairing may become locked to said series 1 freight container;
a means for rotation of said tilt fairing, mounted to said intermodal chassis, that allow said structural frame to both extend away from said series 1 freight container in an open state, and align flush to the end of said series 1 freight container in an upright state such that said plurality of twist locks may enable an apparatus to both place, and remove said series 1 freight container on said intermodal chassis,
further, said means for rotation also allow said tilt fairing to align to the intermodal chassis in a closed position;
assembled as such, a tilt fairing is formed.

4. The tilt fairing of claim 3 further comprising:
said structural frame is lengthened to extend above a series 1 freight container;
said structural frame having a means for connection to a top spindle.

5. In the field of intermodal logistics of roll-up skirt comprising:
a semi-rigid panel substantially filling a gap between a road, said series 1 freight container, a set of wheels on a semi-truck towing said intermodal chassis, and a set of wheels mounted to said intermodal chassis, wherein wind drag may be greatly reduced, and said semi-rigid panel is aligned to an outer edge of said series 1 freight container;
a pliable membrane forming a portion of the roll-up skirt, wherein the pliable membrane may fold to accommodate mechanical equipment bolted to said intermodal chassis,
a plurality of wheels attached to said semi-rigid panel;
a plurality of J-shaped guides having a C-shape cross section that provide a place for said plurality of wheels to roll, in this manner the roll-up skirt may both retract, and roll down to an extended state, wherein aerodynamic improvements may be enjoyed;
further, said plurality of J-shaped guides each terminate adjacent an arced baffle having a U-shaped outer shell that enables said pliable membrane to fold without creasing, and said plurality of guides each have a vertical end enabling said plurality of wheels to stop and provide structure for said semi-rigid panel to remain vertical;
assembled as such, a roll-up skirt is formed.

6. In the field of intermodal logistics a magnetic pliable membrane applicator comprising:
a structural top spindle having a first plurality of fingers for both entering, and exiting a plurality of spooling slots formed on an edge of a magnetic skin, therein enabling the structural top spindle to grab hold of said edge of said magnetic skin to both roll, and unroll said magnetic skin;
further, each end of said structural top spindle has a means for rolling along a top side of said series 1 freight container;
a structural side spindle having a second plurality of fingers for both entering, and exiting a plurality of spooling slots formed on an edge of a magnetic skin, therein enabling the spindle to grab hold of said edge of said magnetic skin to both roll, and unroll said magnetic skin;
further, said structural spindle has a top end with a means for connecting to a top spindle that both rolls, and unrolls a top pliable membrane on a top side of said series 1 freight container;
a plurality of structural outriggers having a means for attaching to said intermodal chassis, a means for both extending to said outer edge of said intermodal chassis, and retracting therein enabling the pliable membrane applicator to be stowed away when not in use;
a means for telescoping at an end of each said plurality of structural outriggers, wherein said structural spindle may reach an end of said series 1 freight container, and an opposite end of said end wherein when retracted the means for telescoping may be stowed away when said plurality of structural outriggers are in a retracted state,
in this manner, said means for telescoping do not snag on landing gear, and both front, and rear tires of said intermodal chassis;
a means for rotating said structural spindle from a prone position to an upright position mounted to said means for telescoping;
a means for rolling said structural spindle both from an end of said series 1 freight container to an opposite end, and from said opposite end to said end, therein enabling the magnetic skin to be both rolled, and unrolled from a side of said series 1 freight container;
assembled as such, a magnetic pliable membrane applicator is formed, and when in use a pair of said magnetic pliable membrane applicators are used, such that the spindle of each said pair of side applicators connect to said structural top spindle and enable applying a separate magnetic pliable membrane to a top side, a left side, and a right side of said series 1 freight container;
assembled as such, a pliable membrane applicator is formed.

7. In the field of intermodal logistics a collapsible skirt comprising:
a semi-rigid panel substantially filling a gap between a road, said series 1 freight container, a set of wheels on a semi-truck towing said intermodal chassis, and a set of wheels mounted to said intermodal chasses, wherein wind drag may be greatly reduced, and said semi-rigid panel is aligned to an outer edge of said series 1 freight container when in an extended state;
a plurality of collapsible braces comprising:
a plurality of structural frames having pivot points with a means for both extending away from said intermodal chassis, and retracting back to said intermodal chassis, therein having both said extended state, and a retracted state,
said plurality of structural frames are spaced to provide stiffness to said semi-rigid panel;
a means for both extending, and retracting said semi-rigid panel;
a portion of said plurality of collapsible braces, and a portion of said motorized means are connected to said means for structural connection on said left side of said intermodal chassis;
a portion of said plurality of collapsible braces are connected to said means for structural connection on said right side of said intermodal chassis;
in this manner, a collapsible skirt is formed.

8. The collapsible skirt of claim 7 wherein said means for extending and retracting is motorized.
